(19) United States
(12) Patent Application Publication
(10) Pub. No.: US 2011/0153536 A1
(43) Pub. Date: Jun. 23, 2011

(54) Computer-Implemented Systems And Methods For Dynamic Model Switching Simulation Of Risk Factors

(76) Inventors: Zhiping Yang, Cary, NC (US); Donald James Erdman, Raleigh, NC (US); Wei Chen, Apex, NC (US)

(21) Appl. No.: 12/640,881

(22) Filed: Dec. 17, 2009

(51) Int. Cl. G06N 5/02; G06F 17/10

(52) U.S. Cl. 706/47; 706/58; 703/2

(57) ABSTRACT

Computer-implemented systems and methods are provided for implementing a dynamic model switching simulator that generates a plurality of simulations. A system and method generates a simulation comprising predictions over a plurality of time periods. Generating a simulation includes generating a first time period prediction using a first model of a first model type. Generating the plurality of subsequent time period predictions includes evaluating the model switching rule to identify whether to switch models for a subsequent time period prediction, generating the subsequent time period prediction using the first model if a switch of models is not identified, and generating the subsequent time period prediction using a second model of a second model type otherwise.

### FIELD

The technology described herein relates generally to data forecasting and more specifically to data model selection in forecasting.

### BACKGROUND

A statistical model is a set of mathematical equations which describe the behavior of an object of study in terms of random variables and their associated probability distributions. For example, in order to forecast and manage business risk, a set of variables is identified that describe the economic state of the world and are forecasted into the future. These variables are often termed risk factors. Each risk factor has different attributes and behaviors and is a unique contributor to the entire economic system. For example, in the financial industry, the most known types of risk and risk factors are: market risk, the risk of a change in the value of a financial instrument due to changes in the value of the underlying components such as stock and interest rates which are driven by risk factors such as exchange rates, commodity prices, stock prices, and interest rates; credit risk, the risk of not receiving promised payments on outstanding lending or investments such as loans and bonds, whose risk factors include economic indicators and values associated with obligors; and operational risk, the risk of losses resulting from inadequate or failed internal processes, people and systems, or from external events, whose risk factors include attrition rates, number of employees, and transaction amounts.

Risk management refers to the design and implementation of procedures for identifying, measuring, and managing risks. The potential for gains and losses can be attributed to two sources. One is the exposures which represent active choices by portfolio managers, and the other one is the movements in the risk factors which are outside a risk manager's control. A risk manager desires to be prepared for possible deleterious movements of the risk factors. To determine the possible values of risk factors, a forecast is performed. The forecast of interest may not be a single point but a distribution of possible values in the future.

The distribution of risk factors may be modeled using various approaches such as: Monte Carlo simulation, historical simulation, and scenario simulation, etc. Using the simulated values of the risk factors, a portfolio is analyzed to calculate a risk measure, such as value at risk. Current forecast approaches typically use a single static simulation method/model during the entire simulation over time. However, such approaches exhibit forecasting problems and may not be suitable to simulate under different situations.

### SUMMARY

In accordance with the teachings herein, computer-implemented systems and methods are provided for generating a plurality of simulations where each simulation makes predictions over a plurality of time periods, where at least one of the generated simulations utilizes a plurality of disparate types of models within a single simulation, and where the plurality of disparate models utilized is dictated by a model switching rule. A model switching rule may be received that identifies one or more conditions for selecting a model to be used for a subsequent time period prediction. A simulation may be generated comprising predictions over a plurality of time periods using a data processor. The generating may include generating a first time period prediction using a first model of a first model type, storing the first time period prediction in a computer-readable memory, and generating a plurality of subsequent time period predictions. The generating one or more of the plurality of subsequent time period predictions may include evaluating the model switching rule to identify whether to switch models for a subsequent time period prediction, generating the subsequent time period prediction using the first model if a switch of models is not identified, generating the subsequent time period prediction using a second model of a second model type if a switch of models to the second model is identified, and storing the subsequent time period prediction in a computer-readable memory. The step of generating a simulation one or more times may be repeated to generate a plurality of simulations.

As another example, a computer-implemented system for generating a plurality of simulations is provided where each simulation makes predictions over a plurality of time periods, where at least one of the generated simulations utilizes a plurality of disparate types of models within a single simulation, and where the plurality of disparate models utilized is dictated by a model switching rule. The system may include a data processing system and a computer-readable memory coupled to the processing system. The data processing system may be configured to execute steps that include receiving a model switching rule identifying one or more conditions for selecting a model to be used for a subsequent time period prediction and generating a simulation comprising predictions over a plurality of time periods using a data processor. Generating a simulation may include generating a first time period prediction using a first model of a first model type, storing the first time period prediction in the computer-readable memory, and generating a plurality of subsequent time period predictions. Generating one or more of the plurality of subsequent time period predictions may include evaluating the model switching rule to identify whether to switch models for the next time period prediction, generating a subsequent time period prediction using the first model if a switch of models is not identified, generating a subsequent time period prediction using a second model of a second model type if a switch of models to the second model is identified, and storing the subsequent time period prediction in the computer-readable memory. The step of generating a simulation may be repeated one or more times to generate a plurality of simulations.

As a further example, a computer-readable medium may be encoded with software instructions for commanding a data processor to perform steps for generating a plurality of simulations where each simulation makes predictions over a plurality of time periods, where at least one of the generated simulations utilizes a plurality of disparate types of models within a single simulation, and where the plurality of disparate models utilized is dictated by a model switching rule. The steps may include receiving a model switching rule identifying one or more conditions for selecting a model to be used for a subsequent time period prediction and generating a simulation comprising predictions over a plurality of time periods using a data processor. Generating a simulation may include generating a first time period prediction using a first model of a first model type, storing the first time period prediction in a computer-readable memory, and generating a plurality of subsequent time period predictions. Generating one or more of the plurality of subsequent time period predictions may include evaluating the model switching rule to identify whether to switch models for a subsequent time period prediction, generating the subsequent time period prediction using the first model if a switch of models is not identified, generating the subsequent time period prediction using a second model of a second model type if a switch of models to the second model is identified, and storing the subsequent time period prediction in a computer-readable memory. The step of generating a simulation may be repeated one or more times to generate a plurality of simulations.

### BRIEF DESCRIPTION OF THE DRAWINGS

FIG. 1 depicts a computer-implemented environment wherein users can interact with a dynamic model switching simulator hosted on one or more servers through a network.

FIGS. 2A and 2B depicts closing values of the 30-year treasury bond from May 2008 to June 2009 and a longer term plot of the 30-year treasury bond from 1977 to 2008, respectively.

FIG. 3 is a block diagram depicting step performed by a dynamic model switching simulator.

FIG. 4 is a block diagram depicting elements of a dynamic model switching simulator.

FIG. 5 depicts a plot of a set of four simulations produced using a switching rule that identifies a number of time periods each models should be used in making predictions of the Euro Libor rate.

FIG. 6 depicts a dynamic model switching simulator configured for implementing a Monte Carlo type switching rule.

FIG. 7 depicts a state machine for implementation as a model switching rule.

FIG. 8 is a flow diagram depicting a computer-implemented method for generating a plurality of simulations, where each simulation makes predictions over a plurality of time periods, where at least one of the generated simulations utilizes a plurality of disparate types of models within a single simulation.

FIGS. 9A, 9B, and 9C depict example processing systems for use in implementing a dynamic model switching simulator.

### DETAILED DESCRIPTION

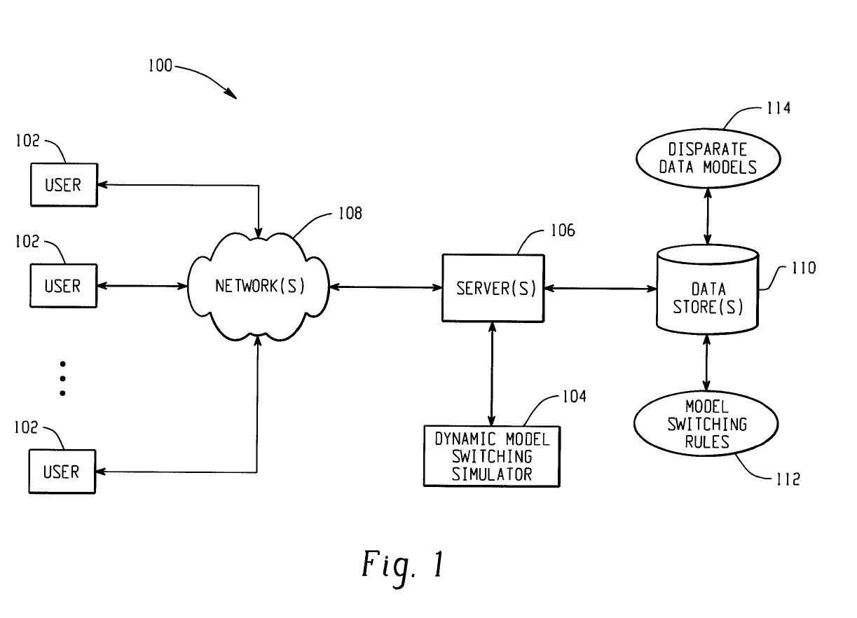

FIG. 1 depicts at 100 a computer-implemented environment wherein users 102 can interact with a dynamic model switching simulator 104. The dynamic switching simulator 104 may be hosted on one or more servers 106 through a network 108. The system 104 contains software operations or routines for generating a plurality of simulations. It should be understood that the dynamic model switching simulator 104 could also be provided on a stand-alone computer for access by a user.

The dynamic model switching simulator 104 generates a plurality of simulations where each simulation makes predictions over a plurality of time periods. Some of the generated simulations utilize a plurality of disparate types of models within a single simulation, where the plurality of disparate models utilized is dictated by a model switching rule. The model switching rule may dictate a switch of models between time period predictions based on criteria that may include random chance, current predicted data values in a simulation, simulation configuration data, as well as others. Such a simulator is able to model complex systems that may be very difficult to emulate using a single static model.

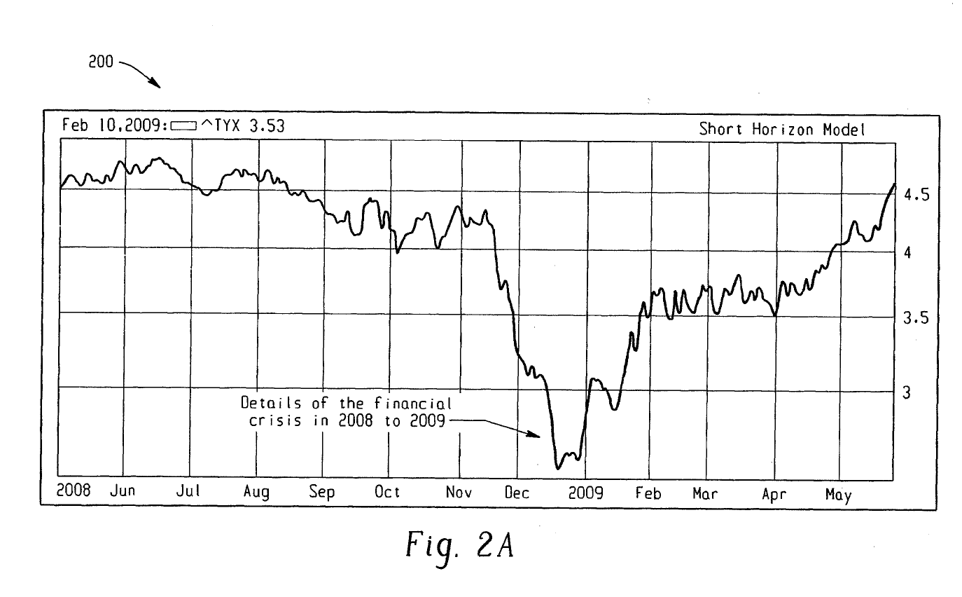

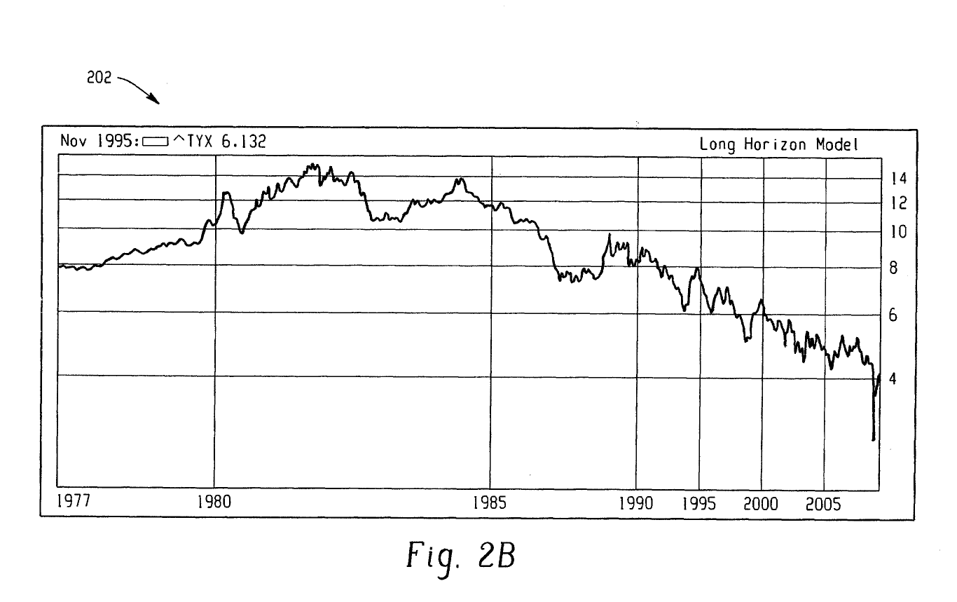

For example, FIGS. 2A and 2B depicts closing values of the 30-year treasury bond from May 2008 to June 2009 and a longer term plot of the 30-year treasury bond from 1977 to 2008, respectively. It may be difficult to develop a single model that can accurately predict the behavior of a commodity such as the 30-year bond that is affected by such a large number of complex factors. This is especially true when the possibility of rare events, such as the financial crisis beginning in November of 2008 is considered.

Rare events can cause a large impact for the financial industry and the economies of the world. Examples of such events include the terrorist attacks of Sep. 11, 2001, the flooding of New Orleans from Hurricane Katrina in 2005, and the financial crisis beginning in 2008. The most powerful statistical techniques may not make short histories reveal such “once-in-a-lifetime events.” It may be possible to predict the probability of an event occurring, but often sufficient data to generate a model is not available.

To make predictions for such a scenario, a dynamic model simulation can be used. The dynamic model simulation may, for each of several simulations, make predictions of a variable for a number of time periods. After each, or a certain number of time periods, a model switching rule may be evaluated. In modeling a scenario with the possibility of rare events, the model switching rule may contain a probability of a rare event occurring. Based on a random number generated before each time period prediction, the dynamic model simulation may decide whether to use a regular model or a rare event model to make the next one or more time period predictions (e.g. for a 0.1% probability rare event, a random number between 1 and 1000 is generated, and if the random number is 999, then the rare event model is used for the next n time period predictions to simulate a rare event occurrence).

A large number of simulation passes making a number of time period predictions in each pass are executed. For each dynamic model simulation pass, the rare event may or may not occur. While none of the passes is expected to exactly model the future, averages and other statistics may be extracted from the set of simulation passes. For example, averages and standard deviations related to simulations of potential business losses may be used to predict a value at risk for determining needed cash reserves to protect against 1-in-50, 1-in-100, or other potential business losses.

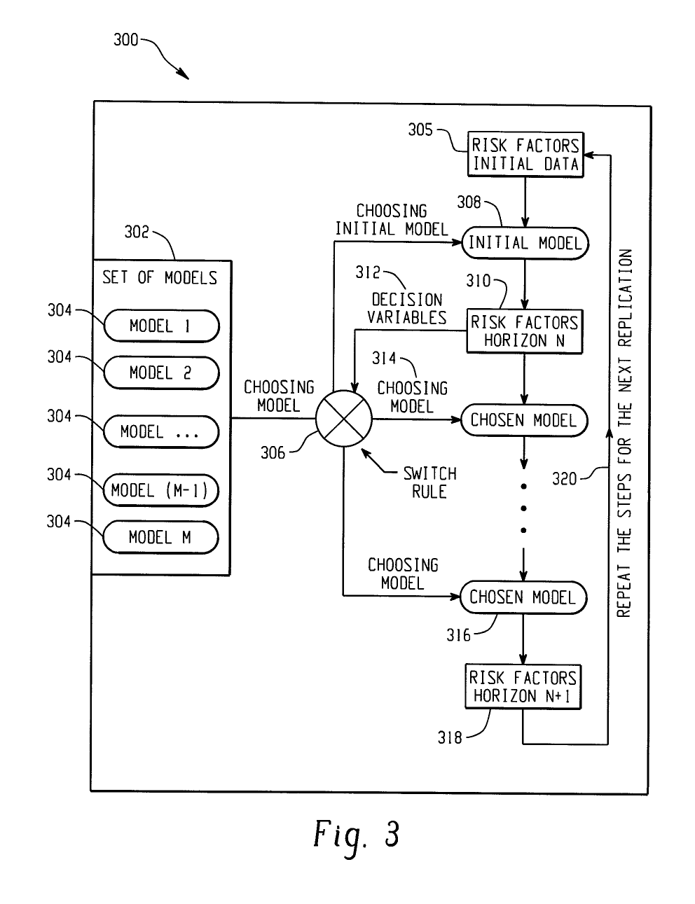

FIG. 3 is a block diagram 300 depicting steps performed by a dynamic model switching simulator. The dynamic model switching simulator includes a model cache 302 containing a plurality of disparate models 304. The models 304 may be of different types, contain differing underlying parameter values, be configured for making predictions over differing time periods (model 1 makes daily predictions, model 3 makes weekly predictions), or have other differences as would be recognized by one skilled in the art.

At 305, initial parameters for risk factors are set at the dynamic model switching simulator. Often, this initial data will be user supplied or extracted from a database. This data will usually be the same for the beginning of each of the number of simulation cycles. In addition to risk factor parameter data, certain configuration data, such as the number of time periods to be predicted in each simulation and the number of overall simulations to be completed, may be specified prior to the first simulation run.

Based on a configuration data setting, the value of the initial data, a random determination, or other criteria, an initial model is selected by the switching rule 306 at 308. A first one or more time period predictions are then made using the first model at 310. After these predictions are generated, the status of certain variables that may be relevant to the evaluation of the switching rule 306 may be provided, as shown at 312. Based on the provided decision variables, random chance, or configuration data settings, the same model may be retained or a new model may be selected by the switching rule 306 at 314. The process is then repeated one or more times, where additional predictions are made and the model switching rule is evaluated for determining whether to switch models for the next set of predictions, as shown at 316, 318. Once a number of predictions identified by the configuration data or other criteria is met, the process 304, 308, 310, 312, 314, 316, 318 is repeated for one or more additional simulations, as shown at 320. Data may then be extracted from the several simulations for identification of future values of variables, associated confidence intervals, and other statistics.

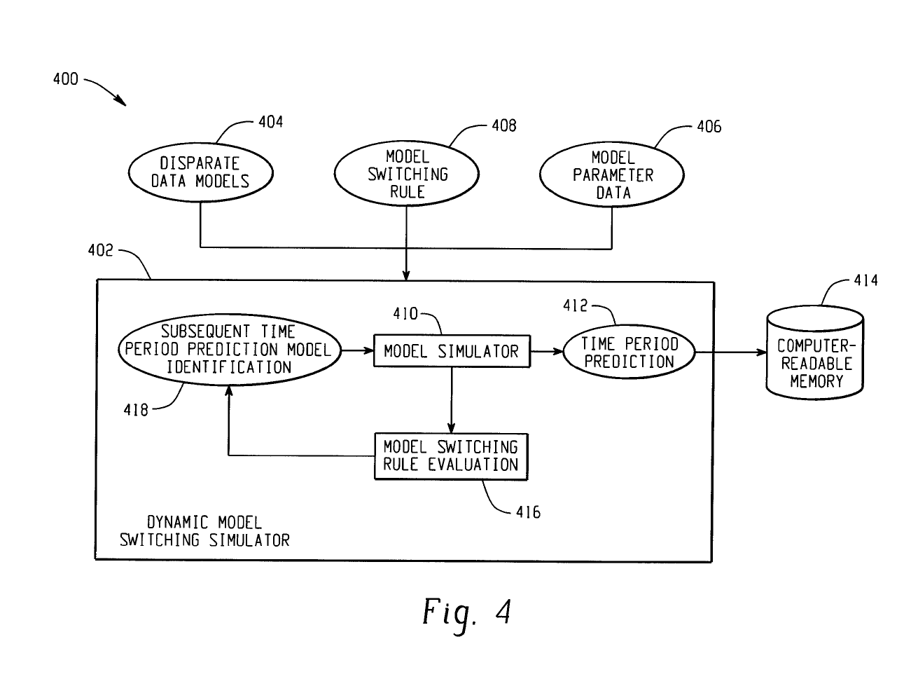

FIG. 4 is a block diagram depicting elements of a dynamic model switching simulator 402. The dynamic model switching simulator 402 receives a plurality of disparate data models 404 along with parameter data 406 associated with each data model. For example, one of the disparate data models 404 may be a log-linear model which may have coefficients supplied from the set of model parameter data 406. The dynamic model switching simulator 402 also receives a model switching rule 408 identifying criteria for switching models between time period predictions within a simulation. A model simulator 410 is supplied with an initial model and an initial state of input variables for making a first one or more time period predictions 412. The one or more time period predictions 412 may be output to a computer-readable memory 414 for subsequent analysis following the generation of multiple simulation runs.

Following generation of one or more time period predictions by the model simulator 410, the model switching rule is evaluated at 416. For example, the model switching rule may be evaluated based on the current state of the running simulation. For example, the model switching rule may select a model based on the status of a long-term and short-term interest rate. In one example, if the short-term interest rate exceeds the long-term interest rate within a simulation, the model switching rule may state that a “bear model” is to be utilized for the next one or more time period predictions based on the inverting of the interest rates. The model switching rule evaluation 416 outputs an identification of a model to be used for the subsequent one or more time periods 418 and the model simulator 410 makes predictions using the identified model 418. The process will continue for the current simulation until a stopping criteria is met. The stopping criteria may be a set number of time period predictions, the reaching of a certain date or time in the simulation, or other criteria. Upon reaching a stopping criteria, the initial conditions may be reset for another simulation if the configuration criteria so instruct.

As another example, the following code segments depicting a series of thresholds related to one month and one year interest rate values, USD_{—}1M and USD+_{—}1Y, respectively, may be utilized as a model switching rule for choosing between five models, identified by their covariance matrices: Cov_Mat1; Cov_Mat2; Cov_Mat3; Cov_Mat4; and Cov_Mat5.

```
/* state-switching of the dynamic covariance simulation*/
method switch kind=trans;
  if USD_1M+USD_1Y <= 0.034 then _covdata_{—} = ‘Cov_Mat1’;
  else if 0.036 >= USD_1M + USD_1Y > 0.034
  then _covdata_{—} = ‘Cov_Mat2’;
  else if 0.037 >= USD_1M + USD_1Y > 0.036
  then _covdata_{—} = ‘Cov_Mat3’;
  else if 0.038 >= USD_1M + USD_1Y > 0.037
  then _covdata_{—} = ‘Cov_Mat4’;
  else _covdata_{—} = ‘Cov_Mat5’;
endmethod;
```

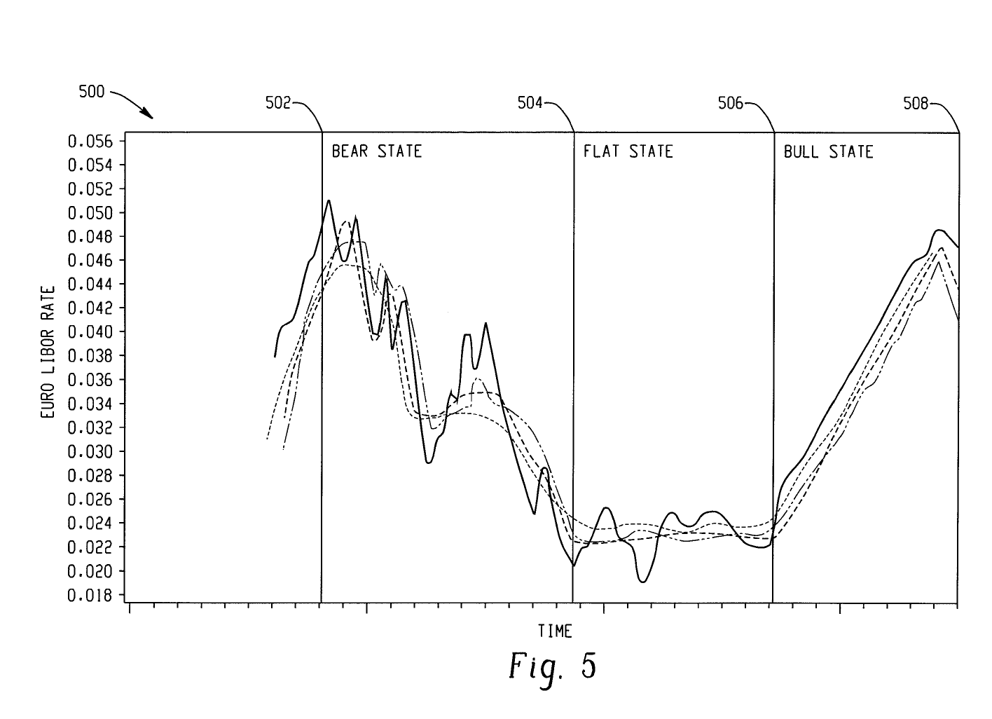

FIG. 5 depicts a plot of a set of four simulations produced using a switching rule that identifies a number of time periods each models should be used in making predictions of the Euro Libor rate. For each of four simulations, a bear model was to be used to make predictions from a first date 502 to a second date 504. A flat state model was then to be utilized in making predictions from the second date 504 to a third date 506. Finally, a bull state model was to be used for making predictions from the third date 506 to the end date of the simulation 508.

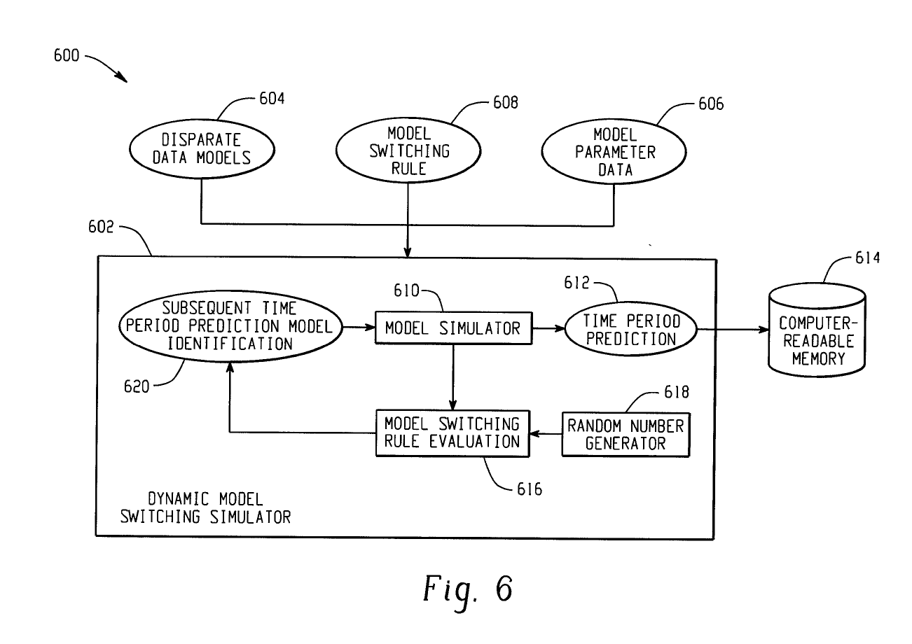

FIG. 6 depicts a dynamic model switching simulator 602 configured for implementing a Monte Carlo type switching rule (e.g., a Markov chain Monte Carlo switching rule). The dynamic model switching simulator 602 receives a plurality of disparate data models 604 along with parameter data 606 associated with each data model. The dynamic model switching simulator 602 also receives a model switching rule 608 identifying criteria for switching models between time period predictions within a simulation. A model simulator 610 is supplied with an initial model and an initial state of input variables for making a first one or more time period predictions 612. The one or more time period predictions 612 may be output to a computer-readable memory 614 for subsequent analysis following the generation of multiple simulation runs.

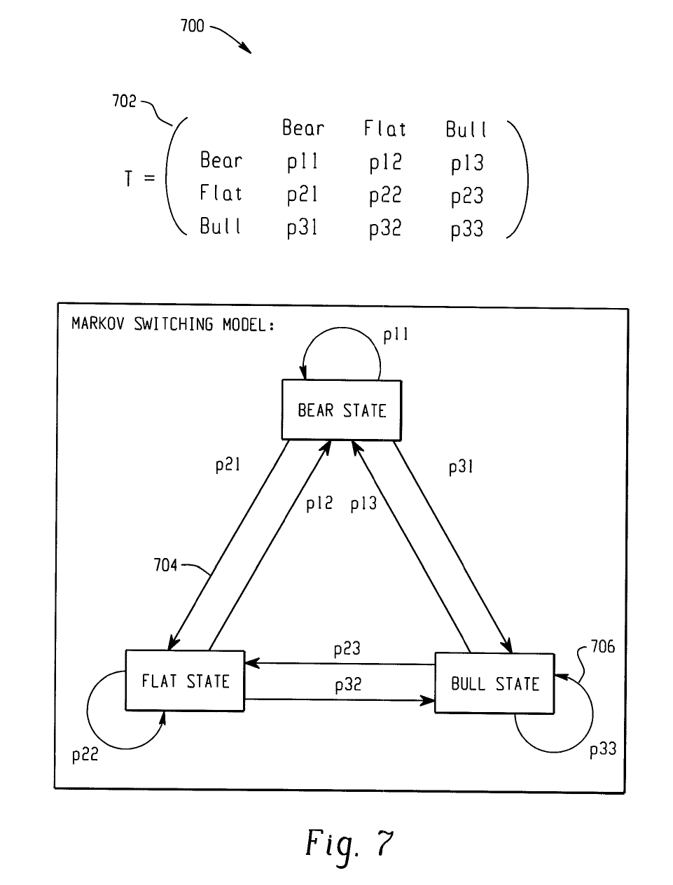

After generating the one or more time period predictions 612 using the first model, the model switching rule is evaluated at 616. The model switching rule is provided a random number from a random number generator 618. The random number is compared to a model switching rule, such as the state machine depicted in FIG. 7 and discussed herein below. Based on that evaluation, a subsequent time period prediction model is identified at 620, and one or more further time period predictions are made by the model simulator 610 utilizing the model identified at 620.

FIG. 7 depicts a state machine switching rule for a Monte Carlo type simulation. A Monte Carlo simulation is one of the more common simulation methods of risk factors in the financial industry. Models utilized may range from simple multivariate normal or lognormal models to more advanced GARCH models. Across the time periods of a simulation produced by a dynamic model switching simulator, a risk factor may follow completely different models or different specifications of the same type of model. For example, long term average rates, covariance, and autocorrelation may be different across the time periods. In the example of FIG. 7, covariances of a model are modified according to a selection by a model switching rule.

A static covariance model may not be able to model varying dynamics of risk factors and may have difficulty in modeling varying relations among risk factors. For example, it may be difficult for a static covariance model to accurately predict a system that has distinctly separate “bearish,” “flat,” and bullish regimes. In the bearish regime, all rates have a downward trend because a contracting economy demands the borrowing rate be made lower. A flat regime is a period of stabilization which may precede a bullish turn or further bearish periods. A bullish regime may include quick expansion with a high demand of borrowing, resulting in upward trending rates.

It may be difficult for one model to capture all of these potential market states. A dynamic model switching simulator enables users to model such a dynamic system much easier. Users may make use of a programmatic interface with dynamic simulation implementations via a platform such as SAS Risk Dimensions to model such regime-switching behavior. SAS Risk Dimensions is described in detail in the “SAS Risk Dimensions: Dynamic Risk Factor Modeling Methodolgy” white paper, SAS Institute, Inc. 2006, the entirety of which is herein incorporated by reference.

FIG. 7 depicts a state machine for implementation as a model switching rule. A matrix depicted at 702 identifies a set of probabilities of transitioning from one state to another during an evaluation of the model switching rule. For example, a value p₂₁ identifies a probability of switching from a bear model to a flat model at a switching rule evaluation, as shown at 704. A value p₃₃ identifies a probability of staying with a bull model at a switching rule evaluation, as shown at 706. The other values in the matrix function in a similar fashion. A random number may be provided to a model switching rule evaluator, and based on that random number and the probabilities identified in the matrix 702, a model is selected for one or more subsequent time period evaluations.

The following code may be utilized to switch among the three models through five time period predictions:

Let Sc and Sn be the current state and next state, respectively, and r is a uniform random number. A switching function F(T, Sc) is defined as:

```
Initialize Sc = Bear at t = 0;
For t = 1 to 5 {
    let r = uniform random number from generator( );
    If Sc= Bear and
      If 0 =< r <= p11, then Sn = Bear;
      If p11 < r <= p11 + p12, then Sn =Flat;
      else Sn = Bull;
    If Sc = Flat and
      If 0 =< r <= p21, then Sn = Bear;
      If p21 < r <= p21 + p22, then Sn = Flat;
      else Sn = Bull;
    If Sc= Bull and
      If 0 =< r <= p31, then Sn = Bear;
      If p31 < r <= p31 + p32, then Sn = Flat;
      else Sn = Bull;
  }
Sc = Sn;
Return Sn;
```

The following steps are used to simulate the future using this transition matrix:

Step 1: Start from t=0. Get the today's state Sc from F(T, Sc)

Step 2: Generate the sample using the corresponding correlation matrix for t=1 and let Sc=Sn.

Step 3: Repeat Step 1 and Step 2 for horizons t=2 to 5;

Step 4: Repeat Step 1 to Step 3 for each simulation;

As another example, an analyst or other user may desire a portfolio model of long term investments such as a portfolio of bonds or mortgages. A first analyst may wish to model the portfolio for several years into the future. The analyst may desire to have weekly projections for the first months, monthly predictions for the remainder of the first year, and yearly projections for the remaining years of each simulation. A model switching rule may be implemented that selects a first model that makes weekly projections for the first months, selects a second model that makes monthly projections for the remainder of the first year, and selects a third model that makes yearly projections for the remainder of each simulation.

As a further example, an analyst may wish to capture more data points during a portion of a simulation where a rare event occurs. For example, a Monte Carlo simulation switching rule may utilize a model that makes monthly projects during a stable state. The Monte Carlo simulation may instead use a model that makes daily projection during a crisis period that may be identified by the switching rule and a generated random number.

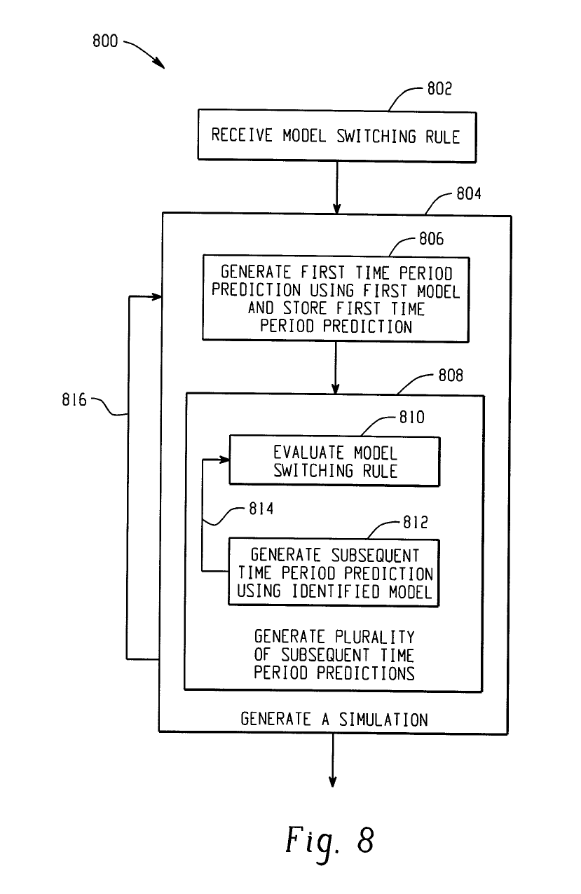

FIG. 8 is a flow diagram depicting a computer-implemented method for generating a plurality of simulations, where each simulation makes predictions over a plurality of time periods, where at least one of the generated simulations utilizes a plurality of disparate types of models within a single simulation. The plurality of disparate models that are utilized is dictated by a model switching rule. A model switching rule identifying one or more conditions for selecting a model to be used for a subsequent time period prediction is received at 802. At 804, a simulation comprising predictions over a plurality of time periods is generated using a data processor. Generating a simulation includes generating a first time period prediction using a first model of a first model type and storing the first time period prediction in a computer-readable memory at 806. At 808, a plurality of subsequent time period predictions are generated. Generating subsequent time period predictions includes evaluating the model switching rule to identify whether to switch models for a subsequent time period prediction at 810. At 812, the subsequent time period prediction is generated using the first model if a switch of model is not identified by the switching rule, and the subsequent time period prediction is generated using a second model of a second model type if a switch of models to the second model is identified. The subsequent time period prediction is then stored in a computer-readable memory. The step of generating a plurality of subsequent time period predictions 808 may be repeated to generate a remainder of the simulation as indicated at 814, and the generate a simulation step 804 may be repeated to generate multiple simulations, as indicated at 816.

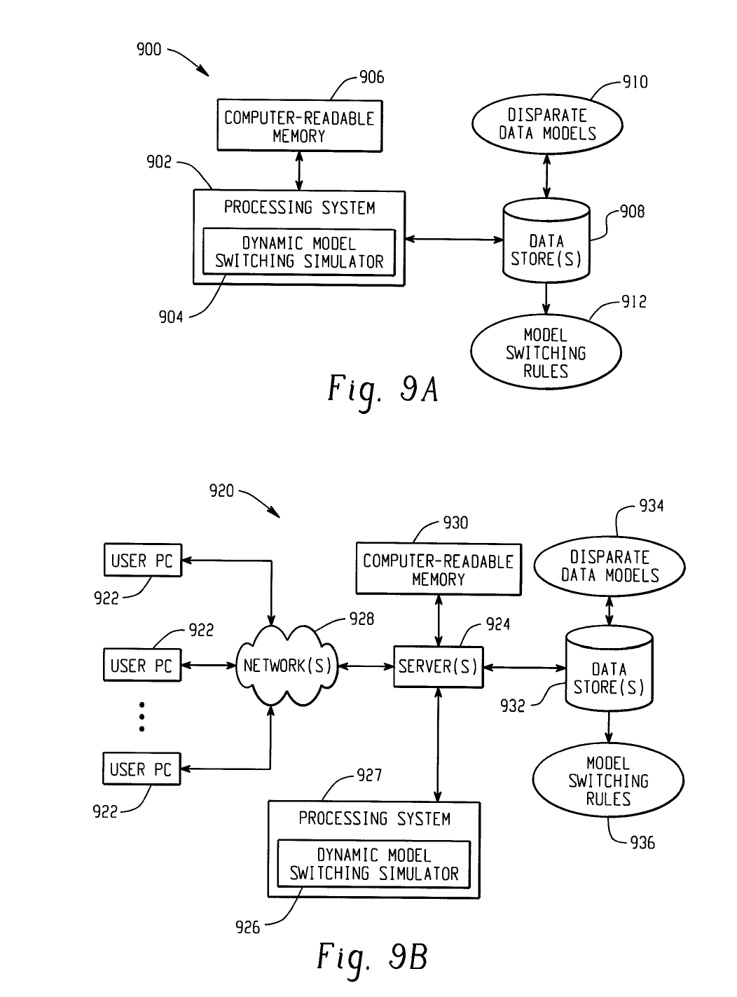

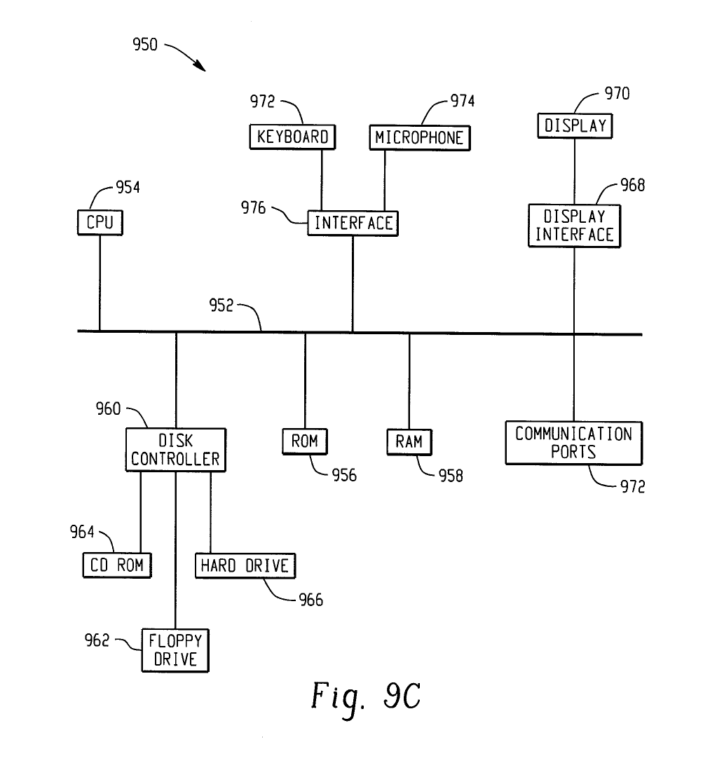

FIGS. 9A, 9B, and 9C depict example systems for use in implementing a dynamic model switching simulator. For example, FIG. 9A depicts an exemplary system 900 that includes a stand alone computer architecture where a processing system 902 (e.g., one or more computer processors) includes a dynamic model switching simulator 904 being executed on it. The processing system 902 has access to a computer-readable memory 906 in addition to one or more data stores 908. The one or more data stores 908 may contain disparate data models 910 as well as model switching rules 912.

FIG. 9B depicts a system 920 that includes a client server architecture. One or more user PCs 922 accesses one or more servers 924 running a dynamic model switching simulator 926 on a processing system 927 via one or more networks 928. The one or more servers 924 may access a computer readable memory 930 as well as one or more data stores 932. The one or more data stores 932 may contain disparate data models 934 as well as model switching rules 936.

FIG. 9C shows a block diagram of exemplary hardware for a stand alone computer architecture 950, such as the architecture depicted in FIG. 9A, that may be used to contain and/or implement the program instructions of system embodiments. A bus 952 may serve as the information highway interconnecting the other illustrated components of the hardware. A processing system 954 labeled CPU (central processing unit) (e.g., one or more computer processors), may perform calculations and logic operations required to execute a program. A processor-readable storage medium, such as read only memory (ROM) 956 and random access memory (RAM) 958, may be in communication with the processing system 954 and may contain one or more programming instructions for performing the method of implementing a dynamic model switching simulator. Optionally, program instructions may be stored on a computer readable storage medium such as a magnetic disk, optical disk, recordable memory device, flash memory, or other physical storage medium. Computer instructions may also be communicated via a communications signal, or a modulated carrier wave.

A disk controller 960 interfaces one or more optional disk drives to the system bus 1652. These disk drives may be external or internal floppy disk drives such as 962, external or internal CD-ROM, CD-R, CD-RW or DVD drives such as 964, or external or internal hard drives 966. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 960, the ROM 956 and/or the RAM 958. Preferably, the processor 954 may access each component as required.

A display interface 968 may permit information from the bus 956 to be displayed on a display 970 in audio, graphic, or alphanumeric format. Communication with external devices may optionally occur using various communication ports 972.

In addition to the standard computer-type components, the hardware may also include data input devices, such as a keyboard 972, or other input device 974, such as a microphone, remote control, pointer, mouse and/or joystick.

This written description uses examples to disclose the invention, including the best mode, and also to enable a person skilled in the art to make and use the invention. The patentable scope of the invention may include other examples. For example, a system and method can be configured herein to simulate: a system with multiple stages or states, a system with rare events, a system that is path dependent, or a system with a long time horizon. As another example, the systems and methods may include data signals conveyed via networks (e.g., local area network, wide area network, interne, combinations thereof, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

It is claimed:

1. A computer-implemented method for generating a plurality of simulations, each simulation making predictions over a plurality of time periods, where at least one of the generated simulations utilizes a plurality of disparate types of models within a single simulation, the plurality of disparate models utilized being dictated by a model switching rule, the method comprising:
receiving a model switching rule identifying one or more conditions for selecting a model to be used for a subsequent time period prediction;
generating a simulation comprising predictions over a plurality of time periods using a data processor, said generating a simulation comprising:
generating a first time period prediction using a first model of a first model type;
storing the first time period prediction in a computer-readable memory;
generating a plurality of subsequent time period predictions, generating one or more of the plurality of subsequent time period predictions comprising:
evaluating the model switching rule to identify whether to switch models for a subsequent time period prediction;
generating the subsequent time period prediction using the first model if a switch of models is not identified;
generating the subsequent time period prediction using a second model of a second model type if a switch of models to the second model is identified;
storing the subsequent time period prediction in a computer-readable memory;
repeating said step of generating a simulation one or more times to generate a plurality of simulations.

2. The method of claim 1, wherein the model switching rule describes a probability that a subsequent time period prediction is to be performed using the second model;
wherein the evaluating the model switching rule generates a random number used in identifying whether to switch models for the subsequent time period prediction.

3. The method of claim 1, wherein the model switching rule describes one or more conditions that determine whether a subsequent time period prediction is to be performed using the second model;
wherein the evaluating the model switching rule evaluates the one or more conditions using a previous time period prediction to identify whether to switch models for the subsequent time period prediction.

4. The method of claim 1, wherein the model switching rule describes a number of time periods the first model is to be used;
wherein a model switch to the second model is identified for generating a subsequent time period prediction after time period predictions for the number of time periods identified in the model switching rule have been made.

5. The method of claim 4, wherein an amount of time represented by a time period prediction by the first model differs from an amount of time represented by a time period prediction by the second model.

6. The method of claim 1, wherein the evaluating the model switching rule is not performed in generating each of the plurality of subsequent time period predictions.

7. The method of claim 1, further comprising generating a subsequent time period prediction using a third model of a third model type if a switch of models to the third model is identified.

8. A computer-implemented system for generating a plurality of simulations, each simulation making predictions over a plurality of time periods, where at least one of the generated simulations utilizes a plurality of disparate types of models within a single simulation, the plurality of disparate models utilized being dictated by a model switching rule, the system comprising:
a data processing system; and
a computer-readable memory coupled to the processing system,
the data processing system being configured to execute steps comprising:
receiving a model switching rule identifying one or more conditions for selecting a model to be used for a subsequent time period prediction;
generating a simulation comprising predictions over a plurality of time periods using a data processor, said generating a simulation comprising:
generating a first time period prediction using a first model of a first model type;
storing the first time period prediction in the computer-readable memory;
generating a plurality of subsequent time period predictions, generating one or more of the plurality of subsequent time period predictions comprising:
evaluating the model switching rule to identify whether to switch models for the next time period prediction;
generating a subsequent time period prediction using the first model if a switch of models is not identified;
generating a subsequent time period prediction using a second model of a second model type if a switch of models to the second model is identified;
storing the subsequent time period prediction in the computer-readable memory;
repeating said step of generating a simulation one or more times to generate a plurality of simulations.

9. The system of claim 8, wherein the model switching rule describes a probability that a subsequent time period prediction is to be performed using the second model;
wherein the evaluating the model switching rule generates a random number used in identifying whether to switch models for the subsequent time period prediction.

10. The system of claim 8, wherein the model switching rule describes one or more conditions that determine whether a subsequent time period prediction is to be performed using the second model;
wherein the evaluating the model switching rule evaluates the one or more conditions using a previous time period prediction to identify whether to switch models for the subsequent time period prediction.

11. The system of claim 8, wherein the model switching rule describes a number of time periods the first model is to be used;
wherein a model switch to the second model is identified for generating a subsequent time period prediction after time period predictions for the number of time periods identified in the model switching rule have been made.

12. The system of claim 11, wherein an amount of time represented by a time period prediction by the first model differs from an amount of time represented by a time period prediction by the second model.

13. The system of claim 8, wherein the evaluating the model switching rule is not performed in generating each of the plurality of subsequent time period predictions.

14. The system of claim 8, wherein the data processing system is further configured for generating a subsequent time period prediction using a third model of a third model type if a switch of models to the third model is identified.

15. A computer-readable medium encoded with software instructions for commanding a data processor to perform steps for generating a plurality of simulations, each simulation making predictions over a plurality of time periods, where at least one of the generated simulations utilizes a plurality of disparate types of models within a single simulation, the plurality of disparate models utilized being dictated by a model switching rule, the steps comprising:
receiving a model switching rule identifying one or more conditions for selecting a model to be used for a subsequent time period prediction;
generating a simulation comprising predictions over a plurality of time periods using a data processor, said generating a simulation comprising:
generating a first time period prediction using a first model of a first model type;
storing the first time period prediction in a computer-readable memory;
generating a plurality of subsequent time period predictions, generating one or more of the plurality of subsequent time period predictions comprising:
evaluating the model switching rule to identify whether to switch models for a subsequent time period prediction;
generating the subsequent time period prediction using the first model if a switch of models is not identified;
generating the subsequent time period prediction using a second model of a second model type if a switch of models to the second model is identified;
storing the subsequent time period prediction in a computer-readable memory;
repeating said step of generating a simulation one or more times to generate a plurality of simulations.

16. The computer-readable medium of claim 15, wherein the model switching rule describes a probability that a subsequent time period prediction is to be performed using the second model;
wherein the evaluating the model switching rule generates a random number used in identifying whether to switch models for the subsequent time period prediction.

17. The computer-readable medium of claim 15, wherein the model switching rule describes one or more conditions that determine whether a subsequent time period prediction is to be performed using the second model;
wherein the evaluating the model switching rule evaluates the one or more conditions using a previous time period prediction to identify whether to switch models for the subsequent time period prediction.

18. The computer-readable medium of claim 15, wherein the model switching rule describes a number of time periods the first model is to be used;
wherein a model switch to the second model is identified for generating a subsequent time period prediction after time period predictions for the number of time periods identified in the model switching rule have been made.

19. The computer-readable medium of claim 18, wherein an amount of time represented by a time period prediction by the first model differs from an amount of time represented by a time period prediction by the second model.

20. The computer-readable medium of claim 15, wherein the evaluating the model switching rule is not performed in generating each of the plurality of subsequent time period predictions.

21. The computer-readable medium of claim 15, wherein the steps further comprise generating a subsequent time period prediction using a third model of a third model type if a switch of models to the third model is identified.
